(19) United States
(12) Patent Application Publication
(10) Pub. No.: US 2005/0188813 A1
(43) Pub. Date: Sep. 1, 2005

(54) Musical String

(75) Inventor: Franz Klanner, Wien (AT)

Correspondence Address: HENRY M FEIEREISEN, LLC, 350 FIFTH AVENUE, SUITE 4714, NEW YORK, NY, 10118, US

(73) Assignee: THOMASTIK-INFELD GESELLSCHAFT M.B.H., Wien (AT)

(21) Appl. No.: 11/067,144

(22) Filed: Feb. 25, 2005

Related U.S. Application Data
(60) Provisional application No. 60/610,738, filed on Sep. 17, 2004.

(30) Foreign Application Priority Data
Mar. 1, 2004 (AT) A 331/2004
Apr. 7, 2004 (AT) A 615/2004
Apr. 28, 2004 (AT) A 738/2004
Sep. 17, 2004 (AT) A 1567/2004

(51) Int. Cl. G10D 3/00

(52) U.S. Cl. 84/297 R

(57) ABSTRACT

In a musical string, in particular for stringed and/or plucking instruments, having a core of natural gut, and at least one coating applied upon the core, the sound, response behavior, long-term stability and allergenic properties are improved when the coating includes a metal selected from the group tin, gold, aluminum, aluminum alloy, titanium, titanium alloy, molybdenum, molybdenum alloy, tungsten, tungsten alloy, palladium, palladium alloy, rhodium, rhodium alloy, or other metal or other metal alloy.

### CROSS-REFERENCES TO RELATED APPLICATIONS

This application claims the priority of Austrian Patent Applications, Serial Nos. A 331/2004, filed Mar. 1, 2004, A 615/2004, filed Apr. 7, 2004, A 738/2004, filed Apr. 28, 2004, and A 1567/2004, filed Sep. 17, 2004, pursuant to 35 U.S.C. 119(a)-(d).

This application also claims the benefit of prior filed U.S. provisional Application No. 60/610,736, filed Sep. 17, 2004, pursuant to 35 U.S.C. 119(e), the subject matter of which is incorporated herein by reference.

### BACKGROUND OF THE INVENTION

The present invention relates to a musical string, in particular for stringed and/or plucking instruments, having a core of natural gut or steel.

Musical strings of natural gut are known for centuries. They represent the first strings for stringed musical instruments. Natural gut has some properties which render them as a preferred musical string material for a long period, in particular for stringed instruments. Natural gut exhibits a fairly high inner attenuation. This inner attenuation is very important in relation to the excitation of a musical string when struck because the string is then able to more rapidly react to the bow change as well as change of the play. A string with less inner attenuation reacts substantially slower to the bow change. It takes longer to excite a stable Helmholtz vibration on a string.

Strings of natural gut suffer, however, a few relevant drawbacks so that their use progressively decreased as a consequence of the introduction of steel core strings about 1919 and in particular the introduction of plastic core strings about 1973. Strings of natural gut are made of dried and intertwined natural gut. Strings of this type typically react intensely to moisture of any kind. Under the influence of air moisture and especially of sweat excreted by the musician, the string partially softens and requires retuning. Typically, strings of this type must be retuned after intense playing for about 20 to 30 minutes. Retuning of the musical instrument is, however, not possible when playing long uninterrupted musical pieces so that the musical recital continuously deteriorates.

It is also known to wrap strings of natural gut with metal wire or metal tape. This approach is unsatisfactory to address the problem of moisture absorption because of the interstices of the wrapping.

Furthermore, current strings of natural gut have insufficient mechanical strength. The impact of the bow and/or the fingers results in a local “fraying” of the surface. As a consequence, there is a change in attenuation and change in sound or p[itch of the string.

Despite these shortcomings, numerous musicians still value the sound and handling characteristics of natural gut strings, in particular when the A string and E string of a violin are concerned.

It is also known to coat strings of natural gut with a varnish in order to reduce moisture absorption. The substantial, localized stress of a musical string during striking causes however the varnish to melt and its ultimate removal by the bow. As a consequence, not only does the string locally change and thus the sound of the string but the bow becomes damaged.

As an alternative to the use of natural gut, the use of a musical string with a core of steel, such as carbon steel or chrome-nickel steel, has been proposed. Musical strings of this type are components that are subjected to great stress and must meet a number of requirements. Musical strings must show a defined behavior during vibration and when excited to vibrate. Vibration behavior of a string and thus of the sound depends, i.a., on the length, mass layer, tension, material and structure. Modification of some of these parameters enables a change in sound as well as handling properties. Not only the sound generated by a string in conjunction with an instrument but also the playing technique that is afforded to the musician is a further criterion for the quality of a musical string.

For vibration-based reasons, the string is used near its material-based limits. It is not uncommon that strings tear when under stress and that strings are subjected during vibration to a high static load as well as to a continuous dynamic load. In addition, there is stress on the material by the musician. Air moisture and especially sweat put strain on the materials. Corrosion on a string leads to a change in diameter. The string loses its mechanical strength and as a result of the loss of mass, is no longer in tune. A musician does not touch the entire string evenly. Rather, certain regions are subjected to more corrosion. Resultant partial irregularities of the diameter and mass prevent the wanted vibration behavior, such as excitation of a Helmholtz vibration on a violin. Stringed instruments are characterized by the generation of a firm tonality and multifaceted sound when several strings are excited simultaneously. This is, however, possible only when the cooperating strings are tuned on all length areas. For example, the strings on a violin must be tuned in intervals of the fifth. In the event one string changes partially its tuning, the tonality of the instrument is destroyed.

It is known to protect the core material and to control the sound by coating the core. Known is an E string of the violin with a steel core which is coated with tin. This solution suffers shortcomings because tin may trigger allergic reactions in people that are susceptible thereto, thus limiting the use of such strings. Also musical strings with a core of natural gut are known to contain allergy-triggering metals, such as nickel.

Further known is an E string of a violin which is coated with gold. The application of gold is disadvantageous because of the poor capability to withstand mechanical stress. When the string is excited by a bow, high pressures and temperature are encountered locally at the striking area, thereby adversely affecting the gold coating. Furthermore, gold-plated strings tend to generate unwanted, high-frequency harmonic vibrations and whistle.

It would therefore be desirable and advantageous to provide an improved musical string which obviates prior art shortcomings.

### SUMMARY OF THE INVENTION

According to one aspect of the present invention, a musical string, in particular for stringed and/or plucking instruments, includes a core of natural gut, and a first coating applied to the core and including a metal selected from the group consisting of tin, gold, aluminum, aluminum alloy, titanium, titanium alloy, molybdenum, molybdenum alloy, tungsten, tungsten alloy, palladium, palladium alloy, rhodium, and rhodium alloy.

As a result, the core of natural gut is protected safely and long-term from moisture so that the string stays in tune for a longer period during playing. In view of the wear resistance of the metal coating, there is no change in the properties of the string even over an extended period. Depending on the type of metal and thickness of the coating, the metal coating is able to allow a control of the sound of the string.

According to another feature of the present invention, a second coating, preferably of gold or nickel, may be disposed between the core and the first coating. This increases the options to add mass to the string so that the inventive construction of a string of natural gut is applicable also for strings with less tuning frequency, i.e. bass strings.

According to another feature of the present invention, the thickness of the first coating and/or the thickness of the second coating may range between 0.05% and 6% of the diameter of the core. In this way, the thickness of the coating is in a harmonic ratio to the thickness of the string of natural gut. As a consequence, an overall harmonic total sound of the string is realized.

Suitably, the thickness of the first coatings and/or the thickness of the second coating may range between 0.1 μm and 18 μm, preferably in the range from 0.15 μm to 10 μm, in particular in the range from 0.2 μm to 5 μm. In this way, superior properties, in particular when used as E-string for the violin, can be realized as far as acoustic and playing technique is concerned.

According to another aspect of the present invention, a musical string, in particular for stringed and/or plucking instruments, includes a core of steel, and a first coating applied to the core and including a metal selected from the group consisting of aluminum, aluminum alloy, titanium, titanium alloy, molybdenum, molybdenum alloy, tungsten, tungsten alloy, palladium, palladium alloy, rhodium, and rhodium alloy.

A musical string of this type can be subjected to great stress and is durable while exhibiting superior acoustic properties and being non-allergenic. The protective oxide layer formed from aluminum, titanium, molybdenum, tungsten, palladium, rhodium, in the presence of air, has a surface structure which is suitable to absorb a large amount of colophony and to retain it over a longer period, without the need for an additional working step of surface treatment. When the string is excited during playing, the response behavior of the string is substantially improved.

According to another feature of the present invention, a second coating, preferably of gold or nickel, may be provided between the steel core and the first coating. In this way, the acoustic properties of a musical string are further enhanced and the application of further coatings is facilitated. The thickness of the first coating and/or the thickness of the second coating may also range between 0.05% and 6% of the core diameter. Suitably, the thickness of the first coating and/or the thickness of the second coating may range between 0.1 μm and 18 μm, preferably in the range from 0.15 μm to 10 μm, in particular in the range from 0.2 μm to 5 μm. In this way, superior properties, in particular when used as E string for the violin, can be realized as far as acoustic and playing technique is concerned.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a cross sectional view of one embodiment of a musical string according to the invention; and

FIG. 2 is a cross sectional view of another embodiment of a musical string according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

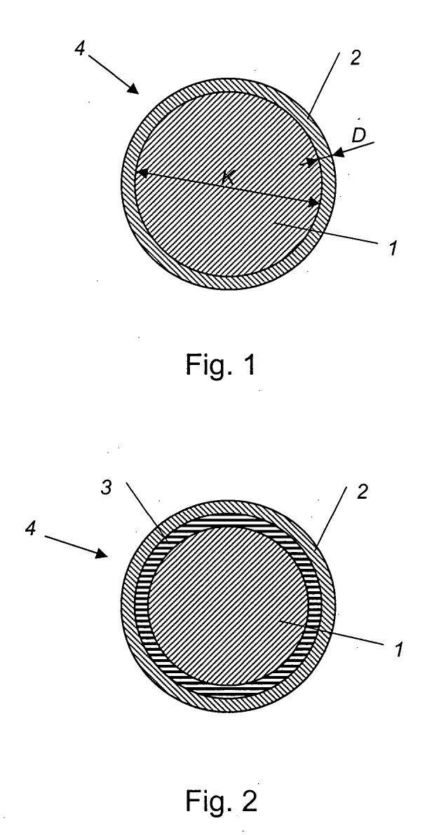

Turning now to the drawing, and in particular to FIG. 1, there is shown a cross sectional view of one embodiment of a musical string according to the invention, generally designated by reference numeral 4, for use in particular for stringed and/or plucking instruments. The musical string 4 has a core 1 which can be made of steel, e.g. carbon steel or chrome-nickel steel, or natural gut, e.g. sheep gut. An example of a musical instrument which can be stringed with musical strings 4 includes the violin family, primarily the violin. Especially suitable are the A string and the E string of the violin. Further examples of musical instruments for use with strings 4 according to the invention include guitars and mandolins. Of course, the string 4 may basically be used for all stringed instruments that are struck, plucked or bowed, such as, e.g., cembalos, harps, banjos, sitar, dulcimer, zither, lute, Ud, P′l-P′a, Chinese lute, gekkin, balalaika, Vina, Tampura, Koto, Soh, etc.

The core 1 is coated with a first coating 2. In the event the core 1 is made of natural gut, the coating 2 is made of a metal selected from the group tin, gold, aluminum, aluminum alloy, titanium, titanium alloy, molybdenum, molybdenum alloy, tungsten, tungsten alloy, palladium, palladium alloy, rhodium, rhodium alloy, or other metal or other metal alloy.

FIG. 2 shows a cross sectional view of another embodiment of a musical string 4 according to the invention. Parts corresponding with those in FIG. 1 are denoted by identical reference numerals and not explained again. The description below will center on the differences between the embodiments. In this embodiment, provision is made for a second coating 3 between the core 1 and the first coating 2. Currently preferred is the use of gold or nickel for making the coating 3, although other materials may, of course, also be applicable, such as, e.g., copper, tungsten, silver, as well as non-metallic materials such as, e.g., PTFE (Teflon, Gore Tex), PVC, silk, viscose. The provision of the intermediate layer in the form of the coating 3 increases the mass layer of the string 4 or adds a damping intermediate layer. As a result, the acoustic properties of the musical string 4 are further improved. Of course, the disposition of several such intermediate layers is conceivable as well. In the event the core 1 is made of steel, the coating 2 is made of a metal selected from the group aluminum, aluminum alloy, titanium, titanium alloy, molybdenum, molybdenum alloy, tungsten, tungsten alloy, palladium, palladium alloy, rhodium, and rhodium alloy. Another example of a suitable metal involves platinum.

In general, the acoustic properties of various metals significantly differ so that conclusions cannot be directly derived from the acoustic properties of a particular metal in the first coating 2 and/or second coating 3 with respect to the acoustic properties of another metal. Thus, no immediate conclusions can be made from the use of a particular metal in the first coating 2 or the second coating 3, having positive acoustic properties and/or imparting positive acoustic properties to the respective musical string, with respect to the use of another metal and its acoustic properties. Also, no immediate conclusions can be made from the physical and chemical material properties of a metal which imparts good acoustic properties in a coating 2, 3 of the musical string 4, with respect to the acoustic properties of a musical string 4 which includes in the coating a different metal of similar physical and chemical material properties.

By coating or ensheathing the core 1 of the musical string 4, at a minimum, there is the advantage of reduced or inhibited moisture absorption compared to a musical string 4 that is not metal coated, even though the applied metal coating may exhibit different acoustic properties in relation to another metal. Therefore, tuning and playing capability of the string 4 with natural gut core 1 become significantly more durable. Furthermore, a metal sheath or coat enables a multifaceted influence of the sound. As a result, the provision of gut strings with superior acoustic properties becomes possible. When the coating 2 contains a metal selected from the group of tin, gold, aluminum, aluminum alloy, titanium, titanium alloy, molybdenum, molybdenum alloy, tungsten, tungsten alloy, palladium, palladium alloy, rhodium, rhodium alloy, the musical string 4 with core 1 of natural gut has, however especially good acoustic properties. In the event of a core 1 of natural gut, the coating 2 and/or coating 3 may contain silver and/or platinum.

Natural gut may be derived from any gut of living beings that have respective digestive organs. An example includes sheep gut which is dried and intertwined.

The core 1 of natural gut of the musical string 4 has a diameter K which ranges from 0.2 mm to 5 mm, preferably in a range from 0.3 mm to 2 mm, in particular in a range from 0.3 mm to 1 mm. Of course, a different core diameter may be suitable in some instances.

In the event, the core 1 of the musical string 4 is made of steel, the core 1 has a diameter K in the range of 0.15 mm to 0.4 mm, preferably in the range of 0.2 mm to 0.3 mm, especially in the range of 0.25 mm to 0.28 mm. A string 4 of this configuration is especially suitable as E string for a violin. While the use of steel is currently preferred, other core material may be applicable as well, such as, for example, other metals, synthetic fibers such as, e.g., carbon fibers, aramide fibers (Kevlar), glass fibers, polyamide fibers (e.g. Nylon) and natural fibers. Preferred steel grading are carbon steels (C content of 0.01% to 0.03%) as well as chrome-nickel steels (Cr content of 17% to 20%, Ni content of 8% to 10%). Of course, any other steel grading may be used for a musical string 4.

Common to both embodiments of FIGS. 1 and 2 is the arrangement of the coating 2 as the outermost coating. As this outermost coating 2 includes a metal selected from the group aluminum, aluminum alloy, titanium, titanium alloy, molybdenum, molybdenum alloy, tungsten, tungsten alloy, palladium, palladium alloy, rhodium, rhodium alloy, platinum, platinum alloy, the musical string 4 is non-corrosive. As a result, the sound of the musical string 4 is durable, irrespective of the strain exerted by the musician or the surroundings (e.g. sea air). It has been shown that the strings 4 exhibit superior acoustic properties and thus positively impact their application.

The surface of the outer protective oxide layer can be formed, without any additional treatment step, from aluminum, titanium, molybdenum, tungsten, palladium, and rhodium, in the presence of air, and is suitable to absorb a great amount of colophony and to retain it over a long time. Colophony is an important factor for the striking or bowing operation. Without colophony, a bowed excitation of a musical string is only possible to a limited extent or not possible at all. As the string 4 is struck and excited, the increasing presence of colophony substantially improves the response behavior of the string 4. Furthermore, long adherence of the string 4 to the bow can be realized and thus greater loudness can be achieved. Overall, the musical string 4 has superior sound and longevity and is easier to handle and to play.

A further advantage of the musical string 4 is also the absence of any allergy-triggering substance. Allergies cause rashes or skin irritation and pose a problem to the civilized world.

The musical string 4 can be made as follows: The coatings 2, 3 are applied upon the core 1 of steel or natural gut, preferably through evaporation by means of a cathode in the presence of high voltage. An example of such a process is described in German Pat. No. DE 43 33 825 C1. Unlike electrolytic or fire-coated strings, coating of the string 4 through evaporation by means of a cathode in the presence of high voltage does not have any non-coated areas. Further, the thickness D of the coating 2, 3 hardly fluctuates. The constant material coat of the musical string 4 supports a reliable vibration of the string 4. The absence of non-coated areas prevents corrosion of the string 4. In particular when the core 1 is made of natural gut, this process results in a deep penetration of the coating or coating metal into the pores of the natural gut surface. Thus, a very high adherence of the coating to the natural gut surface is realized so that the life of the musical string 4 is significantly extended.

It is to be noted that the coating of strings of natural gut by means of common coating processes that are applicable for coating metallic core material is not possible or only possible to a limited extent as these processes would result in a destruction of the string of natural gut or in such an alteration that their acoustic properties are not satisfactory.

Practice has shown that the vibration of the musical string 4, whether with a core 1 of natural gut or with a core 1 of steel, can be optimized when the thickness D of the first coating 2 and/or the thickness D of the second coating 3 ranges between 0.05% and 6% of the diameter K of the core 1. Additional mass layer may be realized by the provision of further intermediate layers which do not necessarily have to satisfy the thickness D to core diameter K ratio of the outer coating 2.

The musical string 4, especially with steel core 1 as E string for the violin, provides superior acoustic and is easy to manufacture, when the thickness D of the first coating 2 and/or the thickness D of the second coating 3 ranges between 0.1 μm and 18 μm, preferably in the range of 0.15 μm to 10 μm, in particular in the range of 0.2 μm to 5 μm. In conjunction with the diameter K of the core 1, this leads to a musical string 4, in particular an E string for a violin, which has superior acoustic and play-technical properties, is moreover durable and free of corrosion, does not expose the player to the risk of an allergenic reaction, and does not absorb moisture and thus is stable over a long time.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. A musical string, in particular for stringed and/or plucking instruments, comprising:
a core of natural gut; and
at least one coating applied to the core and including a metal selected from the group consisting of tin, gold, aluminum, aluminum alloy, titanium, titanium alloy, molybdenum, molybdenum alloy, tungsten, tungsten alloy, palladium, palladium alloy, rhodium, and rhodium alloy.

2. The musical string of claim 1, wherein the core is made of sheep gut.

3. The musical string of claim 1, and further comprising at least a further coating disposed between the core and the first coating.

4. The musical string of claim 3, wherein the further coating is made of gold or nickel.

5. The musical string of claim 3, wherein at least one of the coatings has a thickness in a range between 0.05% and 6% of a diameter of the core.

6. The musical string of claim 3, wherein at least one of the coatings has a thickness in a range between 0.1 μm and 18 μm.

7. The musical string of claim 6, wherein the thickness ranges from 0.15 μm to 10 μm.

8. The musical string of claim 7, wherein the thickness ranges from 0.2 μm to 5 μm.

9. The musical string of claim 3, wherein at least one of the coatings contains silver and/or platinum.

10. The musical string of claim 1, wherein the core 1 has a diameter in the range of 0.2 mm to 5 mm.

11. The musical string of claim 1, wherein the core 1 has a diameter in the range of 0.3 mm to 2 mm.

12. The musical string of claim 1, wherein the core 1 has a diameter in the range of 0.3 mm to 1 mm.

13. A musical string, in particular for stringed and/or plucking instruments, comprising:
a core of steel; and
at least one coating applied to the core and including a metal selected from the group consisting of aluminum, aluminum alloy, titanium, titanium alloy, molybdenum, molybdenum alloy, tungsten, tungsten alloy, palladium, palladium alloy, rhodium, and rhodium alloy.

14. The musical string of claim 13, wherein the core is made of carbon steel.

15. The musical string of claim 14, wherein the carbon steel has a C content of 0.01% to 0.03%.

16. The musical string of claim 13, wherein the core is made of chrome-nickel steel.

17. The musical string of claim 16, wherein the chrome-nickel steels has a Cr content of 17% to 20%, and a Ni content of 8% to 10%.

18. The musical string of claim 13, and further comprising a further coating disposed between the core and the first coating.

19. The musical string of claim 18, wherein the further coating is made of gold or nickel.

20. The musical string of claim 13, wherein at least one of the coatings has a thickness in a range between 0.05% and 6% of a diameter of the core.

21. The musical string of claim 13, wherein at least one of coatings has a thickness in a range between 0.1 μm and 18 μm.

22. The musical string of claim 21, wherein the thickness ranges from 0.15 μm to 1 0 μm.

23. The musical string of claim 22, wherein the thickness ranges from 0.2 μm to 5 μm.

24. The musical string of claim 13, wherein the core has a diameter in the range of 0.15 mm to 0.4 mm.

25. The musical string of claim 13, wherein the core has a diameter in the range of 0.2 mm to 0.3 mm.

26. The musical string of claim 13, wherein the core has a diameter in the range, 0.25 mm to 0.28 mm.
